(19) United States
(12) Patent Application Publication
(10) Pub. No.: US 2026/0295984 A1
(43) Pub. Date: Oct. 1, 2026

(54) MULTILAYER PACKAGING FILM

(71) Applicant: NOVAMONT S.P.A., Novara (IT)

(72) Inventors: Mariangela AIANI, Novara (IT); Catia BASTIOLI, Novara (IT); Paola COMAZZI, Marano Ticino (NO) (IT); SebastÌà GESTI GARCIA, Torino (IT); Tiziana MILIZIA, Novara (IT); Roberto PONTI, Marano Ticino (NO) (IT); Claudio RUSSO, Novara (IT)

(73) Assignee: NOVAMONT S.P.A., Novara (IT)

(21) Appl. No.: 19/489,370

(22) PCT Filed: Jun. 3, 2024
(86) PCT No.: PCT/EP2024/065203

§ 371 Date: Dec. 2, 2025

(30) Foreign Application Priority Data
Jun. 6, 2023 (IT) 102023000011496

(51) Int. Cl. B32B 27/08; B32B 27/36

(52) U.S. Cl. CPC B32B 27/08; B32B 27/36; B32B 2250/03; B32B 2250/40; B32B 2307/728; B32B 2307/7376; B32B 2553/00

(57) ABSTRACT

The present invention relates to a biodegradable multilayer packaging film comprising at least one layer A and one layer B and having an A/B/A arrangement of said layers. Said multilayer film comprises a biodegradable polyester, a polyhydroxyalkanoate and optionally an antifog agent.

The present invention relates to a biodegradable multilayer packaging film comprising a biodegradable polyester, a polyhydroxyalkanoate and optionally an antifog agent.

Packaging films (known as ‘foils’ or ‘films’) are known in the trade and in the literature. Typically, these films are between 3 and 50 μm thick and, for example, are used for packaging food products before the products are placed in refrigerators or packed in containers.

Optimum packaging film is not easy to achieve because a number of special technical characteristics are required for its use, such as:

### Clingability

The property of a film to adhere both to itself and to other non-adherent surfaces, without the addition of an adhesive, is fundamental. This property allows the user of such films to wrap one or more layers of film around an object (e.g. food on a plate) and in this way seal it hermetically.

### Transparency

An essential feature is transparency, which allows the user of such films to identify an object wrapped in them without the need to remove them. From a commercial point of view, it is highly desirable that the film-wrapped product be as clearly visible as possible and it is therefore particularly important that the film does not opacify over time.

### Mechanical Properties

Mechanical properties are the physical properties that fulfil the mechanical performance of the packaging material and its strength. In particular, tensile strength (MPa), elongation at break (%) and elastic modulus (MPa) in both the machine direction (MD) and the transverse direction (TD) are measured.

### Stability on Ageing (Shelf Life)

It is essential that polyesters that impart such good ageing stability to the film that the products are preserved for as long as possible, and in any case at least up to six months, preferably one year, be used.

### Antifog

The antifog property is a feature that is particularly appreciated by the market. It prevents the micro-condensation of moisture that dulls the packaging of fresh and refrigerated products, usually meat and vegetable products.

EP2550330A1 describes a polymer blend, a clingfilm and the process for obtaining it. Specifically, it is a film comprising an aliphatic-aromatic polyester with a low aromatics content.

EP2499189B1 describes a process for the production of a multilayer film comprising 45-70% w/w of an aliphatic-aromatic polyester, 30-55% w/w of PLA with a blow-up ratio of less than or equal to 4:1, and in which the outer layer may comprise PLA and at least the core layer consists of 20-70% w/w of an aliphatic-aromatic polyester, 30-80% w/w of PLA. EP2331634B1 describes a biodegradable polymer mixture comprising 40-95% by weight of aliphatic or aliphatic-aromatic polyester, 5-60% by weight of polyalkylene carbonate, in particular polypropylene carbonate, and 0.1-5% by weight of a copolymer containing an epoxy group based on styrene, acrylic acid ester and/or methacrylic acid ester based on the sum of the two preceding components. The possibility of using antifog is described in all these patents.

EP3642268B1 describes a multilayer film comprising an antifog characterised by the fact that the middle layer comprises starch.

In PCT/EP2021/067193 the applicant has optimised the characteristics of packaging films not only in their antifog capability, but also in their improved unwinding capacity, which is particularly desired for use in industrial packaging wrapping machines.

In order to have a film that really performs in its end use there is a need to develop anisotropy in the tear strength of the film, a necessary condition to ensure a “uniform” cut so that it can be appreciated in domestic use.

Anisotropy means a low tear strength in the transverse direction (TD), and at the same time a tear strength in the machine direction (MD) which is greater than the tear strength in the transverse direction (TD). At the same time, the solution identified must ensure good transparency, excellent clingability and good optical properties, even when antifog agent is present.

It has been found that in order to solve the problem described above it is necessary for the film to be a multilayer film with particular specifications.

One aspect according to the present invention is therefore a multilayer packaging film comprising at least one layer A and one layer B having an A/B/A arrangement of said layers in which layer A comprises:
i. 95-100% by weight of the sum of components i.-ii. of a biodegradable aliphatic aromatic polyester having a melt strength of 0.007 N-0.04 N and:

$$Mn \geq 40000$$

$$Mw / q \leq 90000 ,$$

where Mn and Mw are respectively the number average molecular weight, the weight average molecular weight, and “q” is the percentage by weight of polyester oligomer having a GPC molecular weight≤10000, where the melt strength is measured according to ISO 16790:2005 at 180° C. and γ=103.7s−1 using a 1 mm diameter capillary and L/D=30 at a constant acceleration of 6 mm/sec² and a stretching length of 110 mm; “Mn” and “Mw” are measured by gel permeation chromatography (GPC); and
ii. 0-5% by weight of the sum of components i.-ii. of an antifog agent selected from the esters of a polyfunctional alcohol preferably from the condensation products of a polyfunctional alcohol with a fatty acid, provided that said ester is not a stearate;
   and where layer B comprises:
iii. 60-90% by weight, with respect to the sum of components iii.-v., of at least one polyester comprising:
   a. a dicarboxylic component containing with respect to the total dicarboxylic component:
      a1) 30-60% in moles of units derived from at least one aromatic dicarboxylic acid;
      a2) 70-40% in moles of units derived from at least one saturated aliphatic dicarboxylic acid;
      (a3) 0-5% in moles of units derived from at least one unsaturated aliphatic dicarboxylic acid;
   b. a diol component comprising the total diol component:
      b1) 95-100% in moles of units derived from at least one saturated aliphatic diol;
      (b2) 0-5% in moles of units derived from at least one unsaturated aliphatic diol; and
iv. 10-40% by weight, in relation to the sum of components iii.-v., of one or more polyhydroxyalkanoates;
v. 0-1% by weight, in relation to the sum of components iii.-v., of at least one cross-linking agent and/or chain extender;
   further characterised in that the content of component iv. in the multilayer film is between 1.6 and 11% by weight with respect to components i.-v.

The multilayer packaging films according to the present invention have a total thickness of between 3-50 μm, preferably between 6 and 14 μm, more preferably between 8 and 10 μm. The polyesters that can be used for the production of layer A of the multilayer films according to the invention (component i.) are, for example, those already mentioned in the patents PCT/EP2021/063718 and EP2632970B1 in the name of the Applicant, to which reference is made for the characteristics of the polyesters and the method of preparation.

Preferably, the polyester used for the preparation of the layer A of the film according to the present invention has a gel fraction of less than 5%, more preferably less than 3%, even more preferably less than 1%. The gel fraction is determined by placing a sample of polyester (X1) in chloroform, then filtering the mixture on a 25-45 μm sieve and measuring the weight of the material remaining on the filter screen (X2). The gel fraction is determined as the ratio of the material thus obtained to the weight of the sample, i.e. (X2/X1)×100. The polyesters in layer A are aliphatic aromatic polyesters.

In particular, the aromatic part mainly consists of at least one multifunctional aromatic acid and the aliphatic part comprises at least one aliphatic dicarboxylic acid and at least one aliphatic diol. Multifunctional aromatic acids are dicarboxylic aromatic compounds of the phthalic acid type and their esters and heterocyclic dicarboxylic aromatic compounds of renewable origin and their esters. Terephthalic acid and its esters are particularly preferred.

Aliphatic dicarboxylic acids are defined as dicarboxylic acids with between 2 and 22 carbon atoms in the main chain and their esters. Preferred are dicarboxylic acids from renewable sources, their esters and their mixtures, among these being succinic acid, adipic acid, pimelic acid, suberic acid, sebacic acid, azelaic acid, undecanedioic acid, dodecanedioic acid, brassylic acid and their mixtures. In a particularly preferred embodiment, the aliphatic dicarboxylic acids of the biodegradable polyester to produce films with antifog agents according to the present invention comprise at least 50% in moles of azelaic acid, sebacic acid or adipic acid relative to the total moles of aliphatic dicarboxylic acids.

In the polyester used in film layer A according to the present invention, diols are understood to be compounds bearing two hydroxyl groups. Aliphatic diols from C₂ to C₁₃ are preferred.

Examples of aliphatic diols include: 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,4-cyclohexanedimethanol, neopentylglycol, 2-methyl-1,3-propanediol, dianhydrosorbitol, dianhydromannitol, dianhydroiditol, cyclohexanediol, cyclohexanmethanediol and mixtures thereof. Of these, 1,4-butanediol, 1,3-propanediol and 1,2-ethanediol and their mixtures are particularly preferred. A particularly preferred form of the diol is 1,4-butanediol.

Component i. is characterised by a polyfunctional aromatic acid content of between 30 and 70% in moles, preferably between 40-60% in moles in relation to the total content of dicarboxylic acids in moles.

Advantageously, branched compounds may be added to component i. in an amount of less than 0.5%, preferably less than 0.2% in moles relative to the total content of dicarboxylic acids in moles. These branched compounds are selected from the group of polyfunctional molecules such as, for example, polyacids, polyols and mixtures thereof.

Examples of polyacids are: 1,1,2-ethantricarboxylic acid, 1,1,2,2-ethantetracarboxylic acid, 1,3,5-pentatricarboxylic acid, 1,2,3,4-cyclopentatetracarboxylic acid, malic acid, citric acid, tartaric acid, 3-hydroxyglutaric acid, mucic acid, trihydroxyglutaric acid, hydroxyisophthalic acid, their derivatives and mixtures.

Examples of polyols are: glycerol, hexantriol, pentaerythritol, sorbitol, trimethylolethane, trimethylolpropane, mannitol, 1,2,4-butanetriol, xylitol, 1,1,4,4-tetrakis (hydroxymethyl)cyclohexane, arabitol, adonitol, iditol and their mixtures.

The molecular weight Mn of said component i. is preferably above 20000, more preferably above 40000. As for the polydispersion index of molecular weights, Mw/Mn, this is preferably between 1.5 and 10, more preferably between 1.6 and 5.0 and even more preferably between 1.8 and 2.7.

Molecular weights Mn and Mw may be measured by gel permeation chromatography (GPC). The determination can be carried out with the chromatographic system held at 40° C., using a set of two columns in series (particle diameter 5 μm and 3 μm with mixed porosity), a refractive index detector, chloroform as eluent (flow rate 0.5 ml/min) and using polystyrene as reference standard.

The weight percentage of the oligomers of the polyesters having a molecular weight≤10000 (“q”) is calculated according to the following equation:

$$“ q ” = ( P 1 \cdot F 2 ) / F 1$$

With regard to the weight percentage of oligomers of the polyesters having a GPC molecular weight≤10000, the following have been determined: a polyester sample (approx. 3-4 g, F1) was placed in a 200 ml flask together with 30 ml of chloroform. After complete dissolution of the polyester, 100 ml of a 1:1 v/v solution of methanol with acetone was added and the mixture was then left to stir for two hours.

The mixture was then filtered through a paper filter with a pore size of 8 μm. The polymer remaining on the filter was rinsed with acetone.

The methanol solution with 1:1 v/v acetone was completely evaporated by heating to 70° C. under a stream of air and the weight of the solid fraction remaining was recorded (F2).

A sample of the solid fraction (approximately 10 mg) was dissolved in 10 ml of chloroform and analysed by GPC according to the above method. The percentage of polymer chains with a molecular weight≤10000, (P1), was determined on the basis of the molecular weight distribution curve recorded by the GPC instrument.

Preferably, component i. has an intrinsic viscosity of more than 0.3 dl/g (measured using an Ubbelohde viscosity meter for solutions having a concentration of 0.2 g/dl in CHCl3 at 25° C.), preferably between 0.3 and 2.0 dl/g, more preferably between 0.4 and 1.2 dl/g.

The terminal acid group content of said component i. is preferably less than 100 meq/kg, preferably less than 60 meq/kg and even more preferably less than 40 meq/kg.

The content of terminal acid groups can be measured as is known in the art, for example as is indicated in WO2017216150.

Said component i. is biodegradable. In the meaning according to the present invention, a biodegradable polymer means a polymer that is biodegradable according to EN 13432:2002.

Said component i. can be synthesised according to any of the processes known in the state of the art. In particular, it can be advantageously obtained using a polycondensation reaction.

Advantageously, the process of synthesis can be carried out in the presence of a suitable catalyst. Examples of suitable catalysts include organometallic tin compounds, e.g. stannic acid derivatives, titanium compounds, e.g. orthobutyl titanate, aluminium compounds, e.g. triisopropyl aluminium, compounds of antimony and zinc and zirconium and their mixtures. Layer A may optionally include one or more antifog agents (up to 5% by weight of the sum of components i.-ii.)

In a particularly preferred aspect the antifog agents constituting component ii. of layer A according to the present invention are present and are selected from the esters of a polyfunctional alcohol, preferably from the condensation products of a polyfunctional alcohol with a fatty acid, provided that said ester is not an ester of stearic acid.

Suitable compounds that can be used as antifog agents are polyglyceryl laurate, sorbitan monooleate, sorbitan trioleate and glyceryl monopalmitate.

In a preferred aspect of the invention component ii. of layer A is selected from an ester of a fatty acid having 8 to 18 carbon atoms, more preferably 12 to 16 carbon atoms. In a particularly preferred aspect of the invention the fatty acid ester is selected from polyglyceryl laurate and sorbitan monolaurate.

In the present invention, with regard to antifog agents, the term “esters” means either pure esters or mixtures of esters with two or more individual esters which are different from each other.

The ester characterising antifog agents according to the present invention comprises at least 20% by weight, preferably 30% by weight and even more preferably 60% by weight relative to the ester itself, of a partial ester of the polyfunctional alcohol. In some cases, the partial ester of the polyfunctional alcohol or the condensation product of a polyfunctional alcohol with a fatty acid has been found to be up to 80% or 90% by weight relative to the ester.

Said antifog agents can be added to the polyester either by an extrusion process directly in the desired final concentration, or in a hopper during the film-forming step in the form of a “masterbatch”. By “masterbatch” in the present invention is meant a polyester pellet with a high concentration of the antifog agent. The concentration of the additive in the “masterbatch” is usually 10%.

Preferably, the antifog agent in the multilayer film according to the present invention is biodegradable according to the criteria given in EN13432. More preferably, the antifog agent achieves 10 to 60% biodegradation within a time frame of 10 days within 28 days of testing according to OECD method 301B.

Film layer A according to the present invention may be obtained by reactive extrusion processes. Preferably, said reactive extrusion process is conducted with the addition of peroxides, epoxides or carbodiimides.

Preferably said reactive extrusion process is conducted with peroxides in an amount in the range 0.001-0.2% and preferably 0.01-0.1% by weight with respect to the sum of components i.-ii. fed to the reactive extrusion process.

With regard to the addition of epoxides, these are preferably used in quantities of 0.1-2%, more preferably 0.2-1% by weight of the sum of components i.-ii. fed to the reactive extrusion process. If carbodiimides are used, these are preferably used in quantities of 0.05-2%, more preferably 0.1-1% by weight of the sum of components i.-ii. fed to the reactive extrusion process.

Mixtures of said peroxides, epoxides and carbodiimides can also be used.

Examples of peroxides that may advantageously be used are selected from the group of dialkyl peroxides such benzoyl peroxide, lauroyl peroxide, isononanoyl peroxide, di(t-butylperoxyisopropyl)benzene, t-butyl peroxide, dicumyl peroxide, alpha,alpha′-di(t-butylperoxy)diisopropylbenzene, 2,5-dimethyl-2,5-di(t-butylperoxy)hexane, t-butyl cumyl peroxide, di-t-butyl peroxide, 2,5-dimethyl-2,5-di(t-butylperoxy)hex-3-yne, di(4-t-butyl cyclohexyl)peroxydicarbonate, dicetyl peroxydicarbonate, dimyristyl peroxydicarbonate, 3,6,9-triethyl-3,6,9-trimethyl-1,4,7-triperoxonane, di(2-ethylhexyl)peroxydicarbonate and mixtures thereof.

Examples of epoxides that can be advantageously used are all polyepoxides from epoxidised oils and/or styrene-glycidyl ether-methyl methacrylate, glycidyl ether-methyl methacrylate, within a molecular weight range of 1000 to 10000 and with an epoxide number per molecule in the range 1 to 30 and preferably 5 to 25, and epoxides selected from the group comprising: diethylene glycol diglycidyl ether, polyethylene glycol diglycidyl ether, polyglycerol polyglycidyl ether, 1,2-epoxybutane, polyglycerol polyglycidyl ether, isoprene diepoxide, and cycloaliphatic diepoxides, 1,4-cyclohexandimethanol diglycidyl ether, glycidyl 2-methylphenyl ether, glycerol propoxylatotriglycidyl ether, 1,4-butanediol diglycidyl ether, sorbitol polyglycidyl ether, glycerol diglycidyl ether, tetraglycidyl ether of meta-xylenediamine and diglycidyl ether of bisphenol A and mixtures thereof.

Catalysts may also be used to increase the reactivity of the reactive groups. In the case of polyepoxides, for example, fatty acid salts can be used. Calcium and zinc stearates are particularly preferred.

Examples of carbodiimides that may advantageously be used are selected from the group comprising: poly(cyclooctylene carbodiimide), poly(1,4-dimethylenecyclohexylene carbodiimide), poly(cyclohexylene carbodiimide), poly(ethylene carbodiimide), poly(butylene carbodiimide), poly(isobutylene carbodiimide), poly(nonylene carbodiimide), poly(dodecylene carbodiimide), poly(neopentylene carbodiimide), poly(1,4-dimethylene phenylene carbodiimide), poly(2,2′,6,6′-(tetraisopropyldiphenylene carbodiimide) (Stabaxol® D), poly(2,4,6-triisopropyl-1-phenylene carbodiimide) (Stabaxol® P-100), poly(2,6-diisopropyl-1,3-phenylene e carbodiimide) (Stabaxol® P), poly(tolyl carbodiimide), poly(4,4′-diphenylmethane carbodiimide), poly(3,3′-dimethyl-4,4′-biphenylene carbodiimide), poly(p-phenylene carbodiimide), poly(m-phenylene carbodiimide), poly(3,3′-dimethyl-4,4′-diphenylmethane carbodiimide), poly(naphthylene carbodiimide), poly(isophorone carbodiimide), poly(cumene carbodiimide), p-phenylene bis(ethylcarbodiimide), 1,6-hexamethylene bis(ethyl carbodiimide), 1,8-octamethylene bis(ethyl carbodiimide), 1,10-decamethylene bis(ethyl carbodiimide), 1,12-decamethylene bis(ethyl carbodiimide) and mixtures thereof.

For the purposes of the present invention, layer A of the multilayer film does not contain one or more polyhydroxyalkanoates.

In a particularly preferred aspect, layer A of the multilayer film comprises:
i. 95-100% by weight of the sum of components i.-ii. of a biodegradable aliphatic aromatic polyester having a melt strength of 0.007 N-0.04 N and comprising units of at least one dicarboxylic acid and at least one diol and having:
   Mn≥40000
   Mw/q≤90000,
where Mn and Mw are the number average molecular weight and the weight average molar weight respectively, and “q” is the percentage by weight of the polyester oligomer having a GPC molecular weight≤10000; where the melt strength is measured according to ISO 16790:2005 at 180° C. and γ=103.7 s-l using a capillary of 1 mm diameter and L/D=30 at a constant acceleration of 6 mm/sec2 and a stretching length of 110 mm; “Mn” and “Mw” are measured by gel permeation chromatography (GPC); and
ii. 0-5% by weight of the sum of components i.-ii. of an antifog agent selected from the esters of a polyfunctional alcohol, preferably from the condensation products of a polyfunctional alcohol with a fatty acid, provided that said ester is not a stearate.

The antifog agent (component ii.) is present in quantities between 0.2 and 5%, preferably between 1 and 3%, of the content of the sum of components i.-ii.
Layer B of the multilayer film according to the present invention comprises:
iii. 60-90% by weight, with respect to the sum of components iii.-v., of at least one polyester comprising:
   a dicarboxylic component containing with respect to the total dicarboxylic component:
   a1) 30-60% in moles of units derived from at least one aromatic dicarboxylic acid;
   a2) 70-40% in moles of units derived from at least one saturated aliphatic dicarboxylic acid;
   (a3) 0-5% in moles of units derived from at least one unsaturated aliphatic dicarboxylic acid;
   a diol component comprising with respect to the total diol component:
   b1) 95-100% in moles of units derived from at least one saturated aliphatic diol
   (b2) in moles of units derived from at least one unsaturated aliphatic diol; and
iv. 10-40% by weight, with respect to the sum of components iii)-v), of one or more polyhydroxyalkanoates;
v. 0-1% by weight, with respect to the sum of components i)-v), of at least one cross-linking agent and/or chain extender.

With regard to component iii. of layer B of the multilayer film according to the invention, this is preferably present between 71 and 85% by weight, with respect to the sum of components iii-v, more preferably between 75 and 81% by weight, with respect to the sum of components iii-v.

The aromatic dicarboxylic acids in component a1 are preferably selected from aromatic dicarboxylic acids of the phthalic acid type, preferably terephthalic acid or isophthalic acid and their esters, salts and mixtures, more preferably terephthalic acid and its esters, salts and mixtures.

The aromatic dicarboxylic acids in component a1 are present between 30 and 60% in moles, preferably between 40 and 55% in moles, more preferably between 42 and 52% in moles, even more preferably between 45 and 48% in moles with respect to the total dicarboxylic component.

The saturated aliphatic dicarboxylic acids in component a2 are preferably selected from saturated C2-C24, preferably C4-C13, more preferably C4-C11 dicarboxylic acids, their C1-C24, preferably C1-C4, alkyl esters, their salts and their mixtures. Preferably the saturated aliphatic dicarboxylic acids are selected from succinic acid, 2-ethylsuccinic acid, glutaric acid, 2-methylglutaric acid, adipic acid, pimelic acid, suberic acid, azelaic acid, sebacic acid, undecanedioic acid, dodecanedioic acid, brassylic acid and their C1-24 alkyl esters. In a preferred embodiment of this invention the saturated aliphatic dicarboxylic acid comprises mixtures comprising succinic acid, adipic acid, azelaic acid, sebacic acid, their C1-C24, preferably C1-C4, alkyl esters and mixtures thereof. In a preferred embodiment, said mixtures comprise or consist of at least adipic acid and azelaic acid and contain azelaic acid in an amount of between 5 and 65% in moles, more preferably between 10 and 40% in moles of azelaic acid with respect to the sum of all the saturated aliphatic dicarboxylic acids present.

The saturated aliphatic dicarboxylic acids in component a2 are present between 70 and 40% in moles, preferably between 60 and 45% in moles, more preferably between 58 and 48% in moles, even more preferably between 55° and 52% in moles with respect to the total dicarboxylic component.

The unsaturated aliphatic dicarboxylic acids in component a3 are preferably selected from itaconic acid, fumaric acid, 4-methylene-pimelic acid, 3,4-bis (methylene) nonanedioic acid, 5-methylene-nonanedioic acid, their C1-C24, preferably C1-C4, alkyl esters, their salts and mixtures thereof. In a preferred embodiment according to the present invention, the unsaturated aliphatic dicarboxylic acids comprise mixtures comprising at least 50% in moles, preferably more than 60% in moles, more preferably more than 65% in moles, of itaconic acid and its C1-C24, preferably C1-C4, esters. More preferably the unsaturated aliphatic dicarboxylic acids consist of itaconic acid.

With regard to the saturated aliphatic diols in component b1, these are preferably selected from 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,4-cyclohexanedimethanol, neopentylglycol, 2-methyl-1,3-propanediol, dianhydrosorbitol, dianhydromannitol, dianhydroiditol, cyclohexanediol, cyclohexanmethanediol, dialkylene glycols and polyalkylene glycols with molecular weights of 100-4000 such as polyethylene glycol, polypropylene glycol and mixtures thereof. Preferably the diol component comprises at least 50% in moles of one or more diols selected from 1,2-ethanediol, 1,3-propanediol, 1,4-butanediol. More preferably the diol component comprises or consists of 1,4-butanediol. With regard to the unsaturated aliphatic diols in component b2, these are preferably selected from cis-2-butene-1,4-diol, trans-2-butene-1,4-diol, 2-butyne-1,4-diol, cis-2-pentene-1,5-diol, trans-2-pentene-1,5-diol, 2-pentyne-1,5-diol, cis-2-hexene-1,6-diol, trans-2-hexene-1,6-diol, 2-hexyne-1,6-diol, cis-3-hexene-1,6-diol, trans-3-hexene-1,6-diol, 3-hexene-1,6-diol.

The molecular weight Mn of said component iii. is preferably greater than 20000, more preferably greater than 40000. As for the polydispersity index of the molecular weights, Mw/Mn, this is preferably between 1.5 and 10, more preferably between 1.6 and 5.0, and even more preferably between 1.8 and 2.7.

With regard to component iv. of layer B of the multilayer film according to the invention, it comprises between 10 and 40% by weight, more preferably between 15 and 29% by weight, even more preferably between 19 and 25% by weight with respect to the sum of components iii.-v., of one or more polyhydroxyalkanoates.

A polyhydroxyalkanoate (component iv.) is preferably selected from the group consisting of the lactic acid polyesters, polyhydroxybutyrate, polyhydroxybutyrate-valerate, polyhydroxybutyrate-propanoate, polyhydroxybutyrate-hexanoate, polyhydroxybutyrate-decanoate, polyhydroxy butyrate-dodecanoate, polyhydroxybutyrate-hexadecanoate, polyhydroxybutyrate-octadecanoate, poly 3-hydroxybutyrate-4-hydroxybutyrate. Preferably, the polyhydroxyalkanoate in the composition comprises at least 70% by weight of one or more polyesters of lactic acid. In a particularly preferred form of the invention, component iv. entirely consists of one or more polyesters of lactic acid.

In a preferred embodiment of the invention, the lactic acid polyester (component iv.) has a melting temperature (Tm) between 135 and 160° C. and a glass transition temperature (Tg) between 45-75° C. Commercial examples of lactic acid polyesters having these properties are for example the biopolymer products Ingeo™ 4043D, Ingeo™ 3052D and Luminy® LX175. As regards the melting temperature Tm and the glass transition temperature Tg, these are advantageously determined by differential scanning calorimetry (DSC) using a Perkin Elmer Pyris Diamond calorimeter and the conditions below:
60 s isotherm at −20° C.
1st scan from −20° C. to 200° C. at 20° C./min
60 s isotherm at 200° C.
2nd scan from 200° C. to −20° C. at 10° C./min
60 s isotherm at −20° C.
3rd scan from −20° C. to 200° C. at 20° C./min

The melting temperature (Tm) is determined from the 1st scan, while the glass transition temperature (Tg) is determined from the 3rd scan.

Preferably, the lactic acid polyester has a shear viscosity of between 150 and 1700 Pa·s (measured on dried material containing less than 400 ppm water according to ASTM standard D3835 at T=190° C., shear strain rate=141.6 s−1, D=1 mm, L/D=10).

For the purposes of the present invention, component iv. is included in the multilayer film between 1.6% and 11% by weight with respect to components i.-v., preferably between 4% and 9%.

The composition of layer B of the multilayer film according to the invention comprises between 0% and 1% by weight, preferably 0.05% to 0.5% by weight, more preferably 0.1% to 0.3% by weight with respect to the sum of components i.-v., of at least one crosslinking agent and/or chain extender (component v.).

Said crosslinking agent and/or chain extender is selected from di- and/or polyfunctional compounds bearing carbodiimide or epoxide groups or mixtures thereof.

The di- and polyfunctional compounds bearing carbodiimide groups which are preferably used in the composition according to the present invention are selected from poly(cyclooctylene carbodiimide), poly(1,4-dimethyleneclohexylene carbodiimide), poly(cyclohexylene carbodiimide), poly(ethylene carbodiimide), poly(butylene carbodiimide), poly(isobutylene carbodiimide), poly(nonylene carbodiimide), poly(dodecylene carbodiimide), poly(neopentylene carbodiimide), poly(1, 4-dimethylene phenylene carbodiimide), poly(2,2′, 6,6′-tetraisopropyldiphenylene carbodiimide) (Stabaxol® D), poly(2,4,6-triisopropyl-1,3-phenylene carbodiimide) (Stabaxol® P-100), poly(2,6-diisopropyl-1,3-phenylene carbodiimide) (Stabaxol® P), poly(tolyl carbodiimide), poly(4,4′-diphenylmethane carbodiimide), poly(3,3′-dimethyl-4,4′-biphenylene carbodiimide), poly(p-phenylene carbodiimide), poly(m-phenylene carbodiimide), poly(3,3′-dimethyl-4,4′-diphenylmethane carbodiimide), poly(naphthylene carbodiimide), poly(isophorone carbodiimide), poly(cumene carbodiimide), p-phenylene bis(ethylcarbodiimide), 1,6-hexamethylene bis(ethyl carbodiimide), 1,8-octamethylene bis(ethylcarbodiimide), 1,10-decamethylene bis(ethyl carbodiimide), 1,12-decamethylene bis(ethylcarbodiimide) and mixtures thereof.

Examples of di- and polyfunctional compounds bearing epoxide groups which may advantageously be used in the composition according to the present invention are all polyepoxides from epoxidised oils and/or from styrene-glycidyl-methyl methacrylate or glycidyl-methacrylate, included in a molecular weight range between 1000 and 10000 and having an epoxide number per molecule of between 1 and 30 and preferably between 5 and 25, the epoxides selected from the group comprising: diethylene glycol diglycidyl ether, polyethylene glycol diglycidyl ether, polyglycerol polyglycidyl ether, 2-epoxybutane, polyglycerol polyglycidyl ether, isoprene diepoxide and cycloaliphatic diepoxides, 1,4-cyclohexanedimethanol diglycidyl ether, glycidyl 2-methylphenyl ether, glycerol propoxylated triglycidyl ether, glycerol propoxylated triglycidyl ether, tetraglycidyl ethers of meta-xylenediamine and the diglycidyl ether of bisphenol A and mixtures thereof.

Together with the di- and polyfunctional compounds bearing carbodiimide and epoxide groups, or mixtures thereof such as those described above, catalysts may also be used to increase the reactivity of the reactive groups. In the case of di- and polyfunctional compounds bearing epoxide groups, fatty acid salts, even more preferably calcium stearates and zinc stearates may be used.

In a particularly preferred embodiment of the invention, the crosslinking agent and/or chain extender comprises compounds bearing epoxide groups, preferably of the styrene-glycidyl-methylmethacrylate type.

The present invention relates to a biodegradable multilayer packaging film comprising a biodegradable polyester, a polyhydroxyalkanoate in (inner) layer B and optionally an antifog agent in (outer) layer A.

Preferably, layer B makes up 10-50% of the multilayer film, more preferably 20-40%. The ratio between layers A and B can be determined by scanning electron microscopy (SEM), for example, as is well known to those skilled in the art.

Said film has properties that make it suitable for numerous practical applications related to domestic and industrial consumption. Examples of such applications are food packaging.

Said film may also advantageously be produced by means of blow-moulding processes in which the bubble can be opened allowing for the collection of single-strip reels of film downstream of the film-forming process. This feature is particularly advantageous in terms of the productivity of the production process.

The bubble blow film-forming process is preferably characterised by blow-up ratio (BUR or transverse stretch) values from 2 to 5, and draw-down ratio (DDR or longitudinal stretch) values from 5 to 60 in the machine direction (MD). For the purposes of the present invention, DDR means the measure of elongation undergone by the melt as it exits the extruder in the stretching direction; BUR means the ratio of the bubble diameter to the die diameter. Advantageously, the process parameters are set to have a DDR/BUR ratio of 3 to 15 during bubble blowing. Process co-adjuvants may be added during the film-forming step without affecting the clingability or transparency of the cling films according to the present invention. Such addition is made in accordance with processes known to those skilled in the art. The process co-adjuvants are preferably fatty acid amides, such as for example stearamide, behenamide, erucamide, oleamide, ethylene bis-stearamide, ethylene bis-oleamide and derivatives and anti-blocking agents, such as for example silica, calcium carbonate, talc or kaolin. Fatty acid amides can be added to layer B of the multilayer film according to the invention.

The multilayer films according to the present invention are extremely thin, of the order of 3 to 50 μm. Preferably between 6 and 14 μm, more preferably between 8 and 10 μm.

The multilayer film according to the present invention has the property of high adhesion to itself, as well as to other non-adherent surfaces, e.g. ceramics, glass, metal, plastics such as HDPE, LDPE, PP, PET, PVC.

Also, on account of the physical-chemical characteristics of the biodegradable polyester used, multi-layer clingfilm containing a layer A comprising component i. can be produced without the use of plasticisers or tackifiers such as, for example, polyisobutene or ethylene vinyl acetate. This makes it possible to be aware of a further significant difference between the film according to the present invention and PVC and polyethylene cling films which, due to the presence of the aforementioned additives, have significant limitations on use in the food packaging sector.

In a particularly preferred embodiment, the multilayer film according to the present invention is substantially free of plasticisers and tackifiers, while maintaining optimal clingability.

The multilayer film also has excellent mechanical properties that, through a specific combination of ease of cutting, strength and extensibility, make it particularly suitable for use in food packaging.

Preferably such a multilayer film has elongation at break values between 500% and 1000%, an elastic modulus of between 80 Mpa and 250 Mpa, a breaking load of between 30 Mpa and 50 Mpa in the transverse direction with respect to the film-forming direction and elongation at break values of between 200% and 400%, an elastic modulus of between 200 Mpa and 400 Mpa and a breaking load of between 30 Mpa and 50 Mpa in the longitudinal direction with respect to the film-forming direction.

More preferably, said multilayer film has elongation at break values between 600% and 800%, an elastic modulus between 100 Mpa and 200 Mpa, a breaking load of between 30 Mpa and 48 Mpa in the transverse direction with respect to the film-forming direction and elongation at break values between 230% and 380%, an elastic modulus between 220 Mpa and 400 Mpa and a breaking load of between 32 Mpa and 45 Mpa in the longitudinal direction with respect to the film-forming direction.

Said multilayer film has a ratio of elastic modulus to elongation at break of between 0.5 and 2.0, more preferably between 0.6 and 1.7, in the longitudinal direction to the film-forming direction. With regard to mechanical properties, within the meaning of the present invention these are determined in accordance with ASTM D882 (Tensile Strength at 23° C. and 55% Relative Humidity and vₒ=50 mm/min).

The advantage of the multilayer film according to the invention is that, between ease of cutting, clingability and transparency, it has an optimum combination of properties.

With regard to ease of cutting, the multilayer film according to the invention has a low tear strength in the transverse direction (TD), and at the same time a higher tear strength in machine direction (MD) than the tear strength in the transverse direction (TD). In particular, surprisingly, multilayer films characterised by a tear resistance of between 10 N/mm and 60 N/mm, more preferably between 20 N/mm and 50 N/mm, in the TD and by a tear resistance of less than 100 N/mm in the MD, and in any case higher than the value measured in the TD, are obtained.

This means that the multilayer film can be cut very easily without any deviation when breaking. This enables the product to be used optimally in domestic applications.

With regard to tear resistance, the measurement is made according to the ASTM standard D1922 (23° C.-55% relative humidity).

With regard to clingability, the multilayer film of the invention offers optimum clingability when plasticisers or tackifiers are absent, as described above.

At the same time, the solution described is advantageously characterised by excellent optical properties, given that antifog is present. In particular, it preferably has Haze values <20%, preferably <15%, even more preferably <10%, Clarity values >80%, preferably >85%, even more preferably >90% and Transmittance values >80%, preferably >90%, thereby enabling users to identify objects wrapped in the film without the need to remove it. This feature proves extremely advantageous when it is used for food packaging. With regard to optical properties, these are determined according to ASTM standard D1003.

By biodegradable packaging film according to the present invention is meant a film that is biodegradable and compostable according to EN 13432.

Unless otherwise defined, all terms in the art, notations and other scientific terms used herein are intended to have the meanings commonly understood by those skilled in the art to which this description belongs. In some instances, terms with commonly understood meanings are defined herein for clarity and/or ready reference; the inclusion of such definitions in this description should therefore not be construed as representing a substantial difference from what is generally understood in the art.

The terms “comprising”, “having”, “including” and “containing” are to be understood as open terms (i.e. meaning “including, but not limited to”) and are also to be understood as being less specific than terms such as “consist essentially of”, “consisting essentially of”, “consist of” or “consisting of”.

The terms “consists essentially of”, “consisting essentially of” are to be understood as semi-closed terms, meaning that no other ingredients affecting the new features of the invention are included (optional excipients may therefore be included).

The terms “consists of”, “consisting of” are to be understood as closed terms.

While the invention is susceptible to various alternative modifications, certain preferred embodiments are described in detail below. It is to be understood, however, that there is no intention to limit the invention to the specific embodiments illustrated, but, on the contrary, the invention is intended to cover all modifications, alternatives and equivalents that fall within the scope of the invention as defined in the claims.

The use of “for example”, “etc.”, “or”, indicates non-exclusive alternatives without limitation unless otherwise indicated. The use of “includes” means “includes but not limited to” unless otherwise indicated.

### EXAMPLES

### Analysis

Molecular weights Mn and Mw were measured by gel permeation chromatography (GPC) using a chromatographic system held at 40° C., using a set of two columns in series (5 μm and 3 μm particle diameter with mixed porosity), a refractive index detector, chloroform as eluent (flow rate 0.5 ml/min) and using polystyrene as a reference standard.

The weight percentage of polyester oligomers with a GPC molecular weight≤10000 (“q”) has been measured according to the description.

The melt strength has been measured according to ISO 16790:2005 at 180° C. and γ=103.7s−1 using a capillary of 1 mm diameter and L/D=30 at a constant acceleration of 6 mm/sec2 and a stretching length of 110 mm.

The shear viscosity of polylactic acid has been measured on dried material containing less than 400 ppm water according to ASTM standard D3835 at T=190° C., shear strain rate=141.6 s−1, D=1 mm, L/D=10.

The melt temperature has been measured according to the method given in the description. The MFR was measured at 190° C., 2.16 kg, according to ISO 1133-1 “Plastics—determination of the melt mass-flow rate (MFR) and melt volume flow rate (MVR) of thermoplastics—Part 1: Standard method”).

Tear resistance has been measured according to ASTM D1922 (23° C.-55% relative humidity). The mechanical properties of the film have been measured according to ASTM standard D882 (23° C.-55% relative humidity, v0=50 mm/min).

### Materials

Component i. (PBAT-1): poly(1,4-butylene adipate-co-1,4-butylene terephthalate) having a terephthalic acid content of 47% in moles with respect to the total dicarboxylic component. Said PBAT is characterised by a melt strength of 0.008 N, a number average molecular weight (Mn) of 65768, a weight average molecular weight (Mw) of 125757, a Mw/q value of 43364 and a terminal acid groups content of 39 meq/kg;

Component ii. (A1, antifog): polyglycerol laurate antifog produced by Sabo©.

Component iii. (PBAT-2): poly(1,4-butylene adipate-co-1,4-butylene terephthalate) having a terephthalic acid content of 47% in moles with respect to the total dicarboxylic component. This PBAT is characterised by a melt strength of 0.012 N, a number average molecular weight (Mn) of 98605, a weight average molecular weight (Mw) of 166380 and a terminal acid groups content of 45 meq/Kg;

Component iv.-1 (PLA-1): polylactic acid characterised by a shear viscosity of 204 Pa·s and a melting temperature of 153.0° C.

Component iv.-2 (PLA-2): polylactic acid characterised by a shear viscosity of 1252 Pas and a melting temperature of 149.1° C.

Component iv.-3 (PLA-3): polylactic acid characterised by a shear viscosity of 1239 Pas and a melting temperature of 152.1° C.

Component v.-1 (J1, polyfunctional compound containing epoxy groups): styrene-alkylacrylate-glycidylmethacrylate-based random copolymer with Mw 6800 and epoxy equivalent weight (EEW) 285 g/mol, Joncryl ADR4368 produced by BASF.

Carbodiimide additive (J2): HMV-5CA-LC manufactured by Nisshinbo Chemical Inc. Process co-adjuvant (S1): stearamide Crodamide SR Bead produced by Croda.
M1: Masterbatch comprising 10% w/w of J1 and 90% w/w of PLA-3.
M2: Masterbatch comprising 10. % w/w of S1 and 90% w/w of PBAT-2.

### Layer A

Preparation of composition A1:39.32 kg/hr of ‘PBAT-1’; 0.6 kg/hr of ‘A1’; 0.08 kg/hr of ‘J2’ were fed to a model OMC EBV60/36 twin-screw extruder operating under the following conditions:
Screw diameter (D)=58 mm;
L/D=36;
Screw rotation=140 rpm;
Temperature profile=60-150-180-190×4-150×2° C.;
Throughput: 40 kg/hr;
Vacuum degassing in zone 8 out of 10.

The resulting granules showed an MFR of 7.6 g/10 min (190° C., 2.16 kg, according to ISO standard 1133-1).

### Layer B

TABLE 1
Weight percentage compositions fed
to a model OMC twin-screw extruder

| Composition | PBAT-2 | PLA-1 | PLA-2 | PLA-3 | M1 | M2 | S1 |
|---|---|---|---|---|---|---|---|
| B1 | 78.7 | 17.8 | — | — | 2.5 | 0.8 | 0.2 |
| B2 | 78.7 | — | 17.8 | — | 2.5 | 0.8 | 0.2 |
| B3 | 39.8 | — | — | 59.6 | 0.4 | — | 0.2 |

The compositions shown in Table 1 were fed to a model OMC EBV60/36 twin-screw extruder operating under the following conditions:

$$Screw diameter ( D ) = 58 mm ;$$

$$L / D = 36 ;$$

$$Screw rotation = 140 rpm ;$$

$$Temperature profile = 60 - 150 - 180 - 210 \times 4 - 150 \times 2 ° C . ;$$

Throughput: 40 kg/hr;
Vacuum degassing in zone 8 out of 10.

The MFR of the resulting granules (160° C., 5 kg, according to ISO 1133) is shown in Table 2.

TABLE 2
Melt mass-flow rate (MFR) of granules obtained

| Composition | MFR (g/10 min) |
|---|---|
| B1 | 2.9 |
| B2 | 1.8 |
| B3 | 4.8 |

### Examples: Three-Layer Film with A/B/A Arrangement

Composition A and compositions B1, B2 and B3 (Table 1) were simultaneously fed to a co-extruder to form a three-layer blown film with an A/B/A arrangement (Table 3).

For this purpose the compositions were fed to a first extruder with a screw diameter of 35 mm with an L/D of 30 operating with a thermal profile of 60-135-145×3, to a second extruder with a screw diameter of 40 mm with an L/D of 30 operating with a thermal profile of 60-135-170×3 and to a third extruder with a screw diameter of 35 mm with an L/D of 30 operating with a thermal profile of 60-135-145×3 under the operating conditions described in Table 4. In Example 6, the thermal profile of the 40 mm screw diameter extruder with an L/D of 30 was set at 60-135-145×3. Once molten, the compositions were coupled in a coextrusion-blowing head with an air gap of 0.9 mm and L/D 9 set at 150° C.

The resulting films were then characterised in terms of mechanical properties (Table 5) and optical properties (Table 6).

TABLE 3
Composition and arrangement of the three-layer films

| | Outer | Intermediate | Inner | Weight | Total PLA |
|---|---|---|---|---|---|
| | layer | layer | layer | ratio | content in the |
| | (extruder | (extruder | (layer | between | multilayer |
| Example | 1) | 2) | 3) | layers | film (%) |
| 1 | A1 | B1 | A1 | 39/22/39 | 4.4 |
| 2 | A1 | B2 | A1 | 39/22/39 | 4.4 |
| 3 | A1 | B1 | A1 | 30/40/30 | 8.0 |
| 4 | A1 | B1 | A1 | 20/60/20 | 12.0 |
| (comp) | | | | | |
| 5 | A1 | B3 | A1 | 39/22/39 | 13.2 |
| (comp) | | | | | |
| 6 | A1 | A1 | A1 | 100 | 0.0 |
| (comp) | | | | | |

TABLE 4
Co-extruder film-forming operating conditions.

| | Output in | Output in | Output in | | | |
|---|---|---|---|---|---|---|
| | kg/hr; | kg/hr; | kg/hr; | | | |
| | [rpm] | [rpm] | [rpm] | Thickness | Blowing | Stretch |
| Example | extruder 1 | extruder 2 | extruder 3 | (μm) | ratio | ratio |
| 1 | 1.88 [45] | 6.88 [10] | 11.66 [39] | 12 | 3.2 | 23.6 |
| 2 | 11.92 [45] | 6.99 [10] | 11.92 [40] | 12 | 3.2 | 23.6 |
| 3 | 8.98 [34] | 12.20 [18] | 9.18 [31] | 12 | 3.2 | 23.6 |
| 4 | 6.05 [23] | 17.97 [26] | 6.09 [21] | 12 | 3.2 | 23.6 |
| 5 | 11.92 [45] | 6.42 [11] | 12.05 [41] | 12 | 3.2 | 23.6 |
| 6 | 11.92 [45] | 6.99 [10] | 11.92 [40] | 12 | 3.2 | 23.6 |

TABLE 5
Results for Mechanical Properties and Tear Strength

| | | FILM TRACTION | | | Elmendorf tear strength |
|---|---|---|---|---|---|
| | | ASTM D882 | | | ASTM D1922 |
| | | (23° C. 55% RH - Vo 50 mm/min) | | | (23° C. - 55% RH) |
| | Direction | σb (Mpa) | ε_{b} (%) | E (Mpa) | Force (N/mm) |
| Example 1 | MD | 40 | 349 | 262 | 66 |
| | TD | 42 | 699 | 166 | 36 |
| Example 2 | MD | 33 | 269 | 243 | 71 |
| | TD | 40 | 723 | 158 | 24 |
| Example 3 | MD | 41 | 250 | 378 | 61 |
| | TD | 42 | 673 | 196 | 43 |
| Example 4 (comp) | MD | 44 | 208 | 508 | 84 |
| | TD | 47 | 655 | 246 | 23 |
| Example 5 (comp) | MD | 37 | 153 | 525 | 12 |
| | TD | 23 | 396 | 431 | 5 |
| Example 6 (comp) | MD | 60 | 393 | 101 | 10 |
| | TD | 39 | 806 | 125 | 72 |

TABLE 6
Results for optical properties and film clingability

| | OPTICAL PROPERTIES | | | |
|---|---|---|---|---|
| | ASTM D1003 | | | |
| | TRANSM. | HAZE | CLARITY | |
| | % | % | % | Clingability |
| Example 1 | 92 | 6 | 91 | 5 |
| Example 2 | 92 | 6 | 94 | 5 |
| Example 3 | 93 | 4 | 96 | 4 |
| Example 4 | 93 | 4 | 95 | 1 |
| (comp) | | | | |
| Example 5 | 93 | 6 | 90 | 1 |
| (comp) | | | | |
| Example 6 | 94 | 2 | 99 | 5 |
| (comp) | | | | |

Key to Table 6: The term ‘clingability’ according to the present invention defines the film's ability to adhere to itself and to a surface on a scale of 1 (little) to 5 (a lot).

1. A multilayer packaging film comprising at least one layer A and one layer B and having an A/B/A arrangement of said layers where layer A comprises:
i. 95-100% by weight of the sum of components i.-ii. of a biodegradable aliphatic aromatic polyester with a melt strength of 0.007 N-0.04 N and:
$$Mn \geq 40000$$
$$Mw / q \leq 90000 ,$$
where Mn and Mw are the number average molecular weight and the weight average molecular weight respectively, and “q” is the percentage by weight of polyester oligomer having a molecular weight by GPC≤10000; where the melt strength is measured according to ISO 16790:2005 at 180° C. and γ=103.7s−1 using a capillary of 1 mm diameter and L/D=30 at a constant acceleration of 6 mm/sec2 and a stretching length of 110 mm; “Mn” and “Mw” are measured by gel permeation chromatography (GPC); and
ii. 0-5% by weight of the sum of components i.-ii. of an antifog agent selected from the esters of a polyfunctional alcohol preferably from the condensation products of a polyfunctional alcohol with a fatty acid, provided that said ester is not a stearate;
and where layer B comprises:
iii. 60-90% by weight, with respect to the sum of components iii.-v., of at least one polyester comprising:
a. a dicarboxylic component containing with respect to the total dicarboxylic component:
a1) 30-60% in moles of units derived from at least one aromatic dicarboxylic acid;
a2) 70-40% in moles of units derived from at least one saturated aliphatic dicarboxylic acid;
(a3) in moles of units derived from at least one unsaturated aliphatic dicarboxylic acid;
b. a diol component comprising with respect to the total diol component
b1) 95-100% in moles of units derived from at least one saturated aliphatic diol;
b2) 0-5% in moles of units derived from at least one unsaturated aliphatic diol;
iv. 10-40% by weight, with respect to the sum of components iii.-v., of one or more polyhydroxyalkanoates; and
v. 0-1% by weight, with respect to the sum of the components iii.-v., of at least one cross-linking agent and/or chain extender;
further characterised in that the content of component iv. in the multilayer film is between 1.6 and 11% by weight with respect to components i.-v.

2. The multilayer packaging film according to claim 1 for the production of thin films with a thickness of between 3 and 50 μm.

3. The multilayer packaging film according to claim 1 where said antifog layer A is in an amount of between 0.2 and 5% with respect to the sum of components i.-ii.

4. The multilayer packaging film according to claim 3 in which said antifog layer A is selected from an ester of a fatty acid having 8 to 18 carbon atoms.

5. The multilayer packaging film according to claim 3 in which said antifog layer A is selected between polyglyceryl laurate and sorbitan monolaurate.

6. The multilayer packaging film according to claim 1 in which the layer A does not contain one or more polyhydroxyalkanoates.

7. The multilayer packaging film according to claim 1 in which in layer B component iii. varies between 71 and 85% by weight with respect to the sum of components iii.-v.

8. The multilayer packaging film according to claim 1 in which in layer B component iv. varies between 15 and 29% by weight with respect to the sum of components iii.-v.

9. The multilayer packaging film according to claim 1 in which in layer B component iv. is one or more lactic acid polyesters.

10. The multilayer packaging film according to claim 9 in which the lactic acid polyester (component iv) of layer B has a melting temperature (Tm) between 135 and 160° C. and a glass transition temperature (Tg) between 45 and 75° C.

11. The multilayer packaging film according to claim 1 in which the aromatic dicarboxylic acids in component a1) of layer B are selected from aromatic dicarboxylic acids of the phthalic acid type, their esters, salts and mixtures.

12. The multilayer packaging film according to claim 1 in which the saturated aliphatic dicarboxylic acids in component a2) of layer B are selected from saturated C2-C24 dicarboxylic acids, their C1-C24 alkyl esters, their salts and mixtures thereof.

13. The multilayer packaging film according to claim 12 in which the saturated aliphatic dicarboxylic acids in component a2) are selected from succinic acid, 2-ethylsuccinic acid, glutaric acid, 2-methylglutaric acid, adipic acid, pimelic acid, suberic acid, azelaic acid, sebacic acid, undecanedioic acid, dodecanedioic acid, brassylic acid and their C1-24 alkyl esters.

14. The multilayer packaging films according to claim 1 in which the cross-linking agent and/or chain extender (component v.) in layer B is selected from di- and polyfunctional compounds bearing epoxide groups.

15. The multilayer packaging film according to claim 1 for domestic use.

16. The multilayer packaging film according to claim 1 for the production of thin films with a thickness of between 6 and 14 μm.

17. The multilayer packaging film according to claim 1 for the production of thin films with a thickness of 8 and 10 μm.

18. The multilayer packaging film according to claim 1 where said antifog layer A is in an amount of between 1 and 3% with respect to the sum of components i.-ii.

19. The multilayer packaging film according to claim 1 in which in layer B component iii. varies between 75 and 81% by weight with respect to the sum of components iii-v.

20. The multilayer packaging film according to claim 1 in which in layer B component iv. varies between 19 and 25% by weight with respect to the sum of components iii-v.
